(19) United States
(12) Patent Application Publication
(10) Pub. No.: US 2023/0062744 A1
(43) Pub. Date: Mar. 2, 2023

(54) INFORMATION PROCESSING APPARATUS, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventor: Yoshinori HASEBE, Owariasahi-shi (JP)

(73) Assignee: TOYOTA JIDOSHA KABUSHIKI KAISHA, Toyota-shi (JP)

(21) Appl. No.: 17/893,561

(22) Filed: Aug. 23, 2022

(30) Foreign Application Priority Data
Aug. 25, 2021 (JP) 2021-137494

(51) Int. Cl. G06Q 10/06; G05D 1/00

(52) U.S. Cl. CPC G06Q 10/063112; G05D 1/0027; G05D 1/0077; G05D 1/0038; G05D 2201/0213

(57) ABSTRACT

A first vehicle among a plurality of self-driving vehicles for which travel is remotely managed by a first manager may be into a predetermined situation that requires attention by the first manager. In this case, an information processing apparatus decides one or more second managers other than the first manager as managers to manage travel of one or more second vehicles other than the first vehicle among the plurality of self-driving vehicles on behalf of the first manager.

### CROSS REFERENCE TO THE RELATED APPLICATION

This application claims the benefit of Japanese Patent Application No. 2021-137494, filed on Aug. 25, 2021, which is hereby incorporated by reference herein in its entirety.

### BACKGROUND

### Technical Field

The present disclosure relates to an information processing apparatus, an information processing method and a non-transitory storage medium.

### Description of the Related Art

In Japanese Patent Laid-Open No. 2020-123341, a method for remotely controlling an autonomous vehicle is disclosed. In the method disclosed in Japanese Patent Laid-Open No. 2020-123341, if failing in formulation of a travel plan or failing in change from an autonomous travel mode to a manual travel mode, in a state in which the autonomous vehicle is caused to travel in the autonomous travel mode or the manual travel mode, an autonomous travel control apparatus causes a remote driver to remotely control the autonomous vehicle using a travel simulator.

### SUMMARY

An object of the present disclosure is to enable safe travel of a plurality of self-driving vehicles.

An information processing apparatus according to a first aspect of the present disclosure comprises a controller comprising at least one processor configured to execute deciding, when a first vehicle among a plurality of self-driving vehicles for which travel is remotely managed by a first manager comes into a predetermined situation that requires attention by the first manager, one or more second managers other than the first manager as managers to manage travel of one or more second vehicles other than the first vehicle among the plurality of self-driving vehicles on behalf of the first manager.

An information processing method according to a second aspect of the present disclosure comprises deciding, when a first vehicle among a plurality of self-driving vehicles for which travel is remotely managed by a first manager comes into a predetermined situation that requires attention by the first manager, one or more second managers other than the first manager as managers to manage travel of one or more second vehicles other than the first vehicle among the plurality of self-driving vehicles on behalf of the first manager.

A non-transitory storage medium according to a third aspect of the present disclosure is a non-transitory storage medium storing a program for causing a computer to execute an information processing method, wherein the information processing method comprises deciding, when a first vehicle among a plurality of self-driving vehicles for which travel is remotely managed by a first manager comes into a predetermined situation that requires attention by the first manager, one or more second managers other than the first manager as managers to manage travel of one or more second vehicles other than the first vehicle among the plurality of self-driving vehicles on behalf of the first manager.

According to the present disclosure, it is possible to enable safe travel of a plurality of self-driving vehicles.

### BRIEF DESCRIPTION OF THE DRAWINGS

FIG. 1 is a diagram illustrating a schematic configuration of a management system;

FIG. 2 is a diagram illustrating an example of correspondence between each manager and vehicles managed by the manager;

FIG. 3 is a diagram illustrating an example of change in the correspondence between each manager and the vehicles managed by the manager;

FIG. 4 is a block diagram schematically illustrating an example of a functional configuration of a management server;

FIG. 5 is a diagram illustrating an example of a table configuration of manager information stored in a manager information database; and

FIG. 6 is a flowchart of a change process.

### DESCRIPTION OF THE EMBODIMENTS

A case is assumed where a manager who performs self-driving vehicle travel management (hereinafter also referred to as “a first manager”) remotely performs travel management of a plurality of self-driving vehicles. Here, the first manager performs the travel management of the self-driving vehicles by monitoring situations of the self-driving vehicles and performing operations for the self-driving vehicles. There may be a case where, during the travel management, one self-driving vehicle among the plurality of self-driving vehicles for which the first manager manages travel comes into a predetermined situation that requires attention by the first manager.

Then, the first manager performs, while paying attention to the self-driving vehicle that has come into the predetermined situation (hereinafter also referred to as “a first vehicle”), travel management of the one or more self-driving vehicles other than the first vehicle. Therefore, there is a possibility that, while the first manager is paying attention to the first vehicle, sufficient attention is not paid to the travel management of the one or more self-driving vehicles other than the first vehicle.

Therefore, a controller, comprising at least one processor, of an information processing apparatus according to a first aspect of the present disclosure decides, when the first vehicle comes into a predetermined situation that requires attention by the first manager, one or more second managers other than the first manager as managers to manage travel of one or more second vehicles on behalf of the first manager. Here, the vehicles other than the first vehicle among the plurality of self-driving vehicles for which travel is managed by the first manager may be referred to as the second vehicles.

Thereby, when the first vehicle managed by the first manager comes into the predetermined situation, the one or more second vehicles are excluded from targets of the travel management by the first manager. Then, the number of self-driving vehicles for which the first manager manages travel decreases. Therefore, it becomes possible for the first manager to pay attention to the first vehicle in a state in which the burden of managing travel of self-driving vehicles is reduced. The one or more second vehicles excluded from the targets of the travel management by the first manager are targeted by travel management by the one or more second managers. In this way, travel management of the first vehicle and the second vehicles are shared by the first manager and the second managers. As a result, it is possible to enable safe travel of the plurality of self-driving vehicles including the first vehicle and the second vehicles.

A specific embodiment of the present disclosure will be described below based on drawings. The sizes, materials and shapes of components described in the present embodiment, a relative arrangement of the components and the like are not intended to limit the technological range of the present disclosure only thereto unless otherwise stated.

### Embodiment

### (Outline of System)

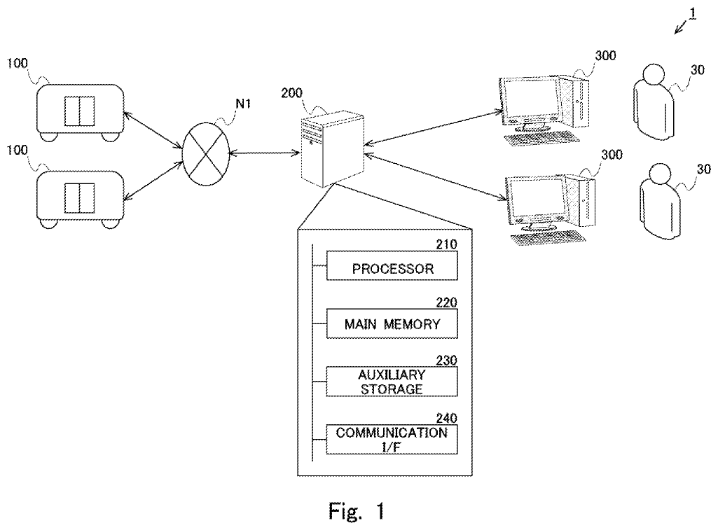

A management system 1 in the present embodiment will be described based on FIGS. 1 to 3. FIG. 1 is a diagram illustrating a schematic configuration of the management system 1. The management system 1 is configured including a plurality of vehicles 100, a management server 200 and a plurality of manager terminals 300.

In the management system 1, the plurality of vehicles 100 and the management server 200 are mutually connected via a network N1. As the network N1, a WAN (wide area network), which is a worldwide public communication network such as the Internet, or a telephone communication network for mobile phones and the like may be adopted. Further, in the management system 1, the management server 200 and the plurality of manager terminals 300 are mutually connected via a network constructed in a predetermined area (hereinafter also referred to as “an in-area network”. As the in-area network, for example, a LAN (local area network) constructed in a predetermined area may be adopted.

(Vehicle)

The vehicles 100 are self-driving vehicles without a crew member such as a driver. The vehicles 100 are, for example, vehicles to transport passengers. Each vehicle 100 transmits information about a situation of the vehicle 100 (hereinafter also referred to as “situation information”) to the management server 200 via the network N1. In the present embodiment, the situation information is video of the inside and outside of the vehicle 100 taken by cameras provided for the vehicle 100. The video of the inside of the vehicle 100 includes a state of the inside of the vehicle 100, including a state of passengers of the vehicle 100 and the like. The video of the outside of the vehicle 100 includes a state around the vehicle 100, including a state of a road on which the vehicle 100 is traveling and the like. In the present embodiment, the vehicles 100 are vehicles to transport passengers. The vehicles 100, however, do not necessarily have to be vehicles to transport passengers. The vehicles 100 may be, for example, vehicles to transport baggage.

(Manager Terminal)

The manager terminals 300 are terminals used by managers 30. The manager terminals 300 are, for example, computers used by the managers 30. The manager terminals 300 display situation information about the vehicles 100 received by the management server 200 to the managers 30. Specifically, the manager terminals 300 display video of the inside and outside of the vehicles 100 included in the situation information. Thereby, the managers 30 can grasp situations of the inside and outside of the vehicles 100.

The managers 30 remotely perform work of managing travel of the vehicles 100 based on the situations of the inside and outside of the vehicles 100 displayed on the manager terminals 300. That is, the managers 30 manage travel of the vehicles 100 without boarding in the vehicles 100. The managers 30 monitor, for example, states of the vehicles 100 (for example, states around the vehicles 100, states of passengers or the like) based on the situation information. If an abnormality occurs in a vehicle 100, a manager 30 uses a manager terminal 300 to cause the vehicle 100 to make an emergency stop and make an announcement to passengers of the vehicle 100.

Each manager 30 performs an operation for assisting self-driving of a vehicle 100 using the manager terminal 300 based on a situation of the outside of the vehicle 100. For example, the manager 30 confirms safety around the vehicle 100 based on video of the outside of the vehicle 100 and performs an operation to instruct the vehicle 100 to get ahead of another vehicle. Further, the manager 30 confirms safety around the vehicle 100 based on the video of the outside of the vehicle 100 and performs an operation to allow the vehicle 100 to turn right or left at an intersection. The manager 30 gives an instruction to get ahead of a vehicle or allows the vehicle 100 to turn right or left at an intersection, for example, by pressing a particular button displayed on the manager terminal 300. When the particular button is pressed, the manager terminal 300 generates information for assisting self-driving. Then, the information for assisting self-driving vehicle is transmitted to the vehicle 100 via the management server 200. In this way, assistance for self-driving of the vehicle 100 is performed by the manager 30. In addition to the assistance for self-driving of the vehicle 100, the manager 30 may steer the vehicle 100 as necessary.

(Management Server)

The management server 200 is a server that manages work of the plurality of managers 30. The management server 200 receives situation information about each vehicle 100 from the vehicle 100 via the network N1. Thereby, it becomes possible for the management server 200 to grasp situations of the inside and outside of the vehicles 100. Further, the management server 200 transmits the situation information about the vehicles 100 to the manager terminals 300 via the in-area network.

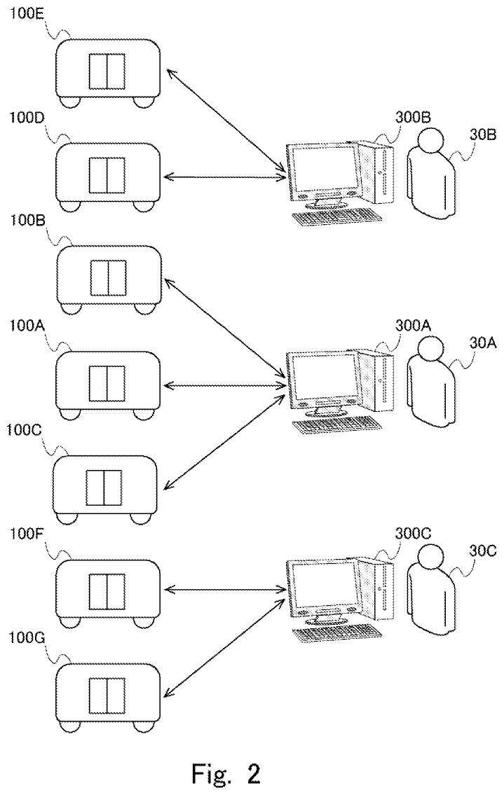

FIG. 2 is a diagram illustrating an example of correspondence between each manager 30 and vehicles 100 managed by the manager 30. In the example illustrated in FIG. 2, three managers 30 (managers 30A, 30B and 30C) perform travel management of seven vehicles 100 (vehicles 100A, 100B, 100C, 100D, 100E, 100F and 100G). As illustrated in FIG. 2, the manager 30A performs management of the three vehicles 100A, 100B and 100C using a manager terminal 300A. The manager 30B performs management of the two vehicles 100D and 100E using a manager terminal 300B. The manager 30C performs management of the two vehicles 100F and 100G using a manager terminal 300C.

The management server 200 detects a situation of each vehicle 100 based on situation information received from the vehicle 100. At this time, there may be a case where a vehicle 100 comes into a predetermined situation. At this time, the management server 200 changes the correspondence between each manager 30 and the vehicles 100 managed by the manager 30. Here, the predetermined situation is a situation in which the vehicle 100 requires attention by a corresponding manager 30. The predetermined situation is, for example, a situation in which an abnormality has occurred in the vehicle 100. Further, the predetermined situation is, for example, an operation related to travel of the vehicle 100 by the manager 30 is required for assistance for self-driving of the vehicle 100.

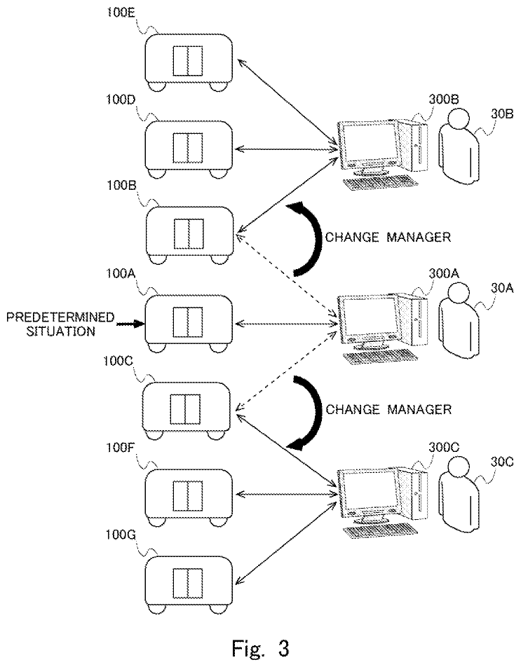

FIG. 3 is a diagram illustrating an example of change in the correspondence between each manager 30 and the vehicles 100 managed by the manager 30. In the example illustrated in FIG. 3, it is assumed that the vehicle 100A has come into a predetermined situation in the example illustrated in FIG. 2. In this case, a manager to manage the vehicle 100B is changed from the manager 30A to the manager 30B as illustrated in FIG. 3. Further, a manager to manage the vehicle 100C is changed from the manager 30A to the manager 30C as illustrated in FIG. 3. By the managers of the vehicles 100B and 100C being changed by the management server 200, the manager 30A performs management travel management of the vehicle 100A without performing travel management of the vehicles 100B and 100C. Details of the method for changing managers of the vehicles 100 by the management server 200 will be described later.

The management server 200 is configured including a computer having a processor 210, a main memory 220, an auxiliary storage 230 and a communication interface (communication I/F) 240. The processor 210 is, for example, a CPU (central processing unit) or a DSP (digital signal processor). The main memory 220 is, for example, a RAM (random access memory). The auxiliary storage 230 is, for example, a ROM (read-only memory). Further, the auxiliary storage 230 is, for example, an HDD (hard disk drive) or a disk recording medium like a CD-ROM, a DVD disk or a Blu-ray Disc. The auxiliary storage 230 may be a removable medium (portable storage medium). Here, as the removable medium, for example, a USB memory or an SD card is exemplified. The communication I/F 240 is, for example, a LAN (local area network) interface board or a wireless communication circuit for wireless communication.

In the management server 200, an operating system (OS), various kinds of programs, various kinds of information tables and the like are stored in the auxiliary storage 230. In the management server 200, various kinds of functions as described later can be realized by the processor 210 loading a program stored in the auxiliary storage 230 to the main memory 220 and executing the program. However, a part or all of the functions in the management server 200 may be realized by a hardware circuit like an ASIC or an FPGA. The management server 200 is not necessarily required to be realized by a single physical configuration but may be configured by a plurality of computers cooperating with one another. Each vehicle 100 is configured including a computer similarly to the management server 200.

(Functional Configuration)

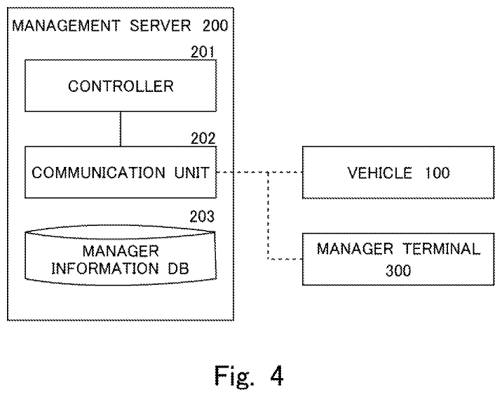

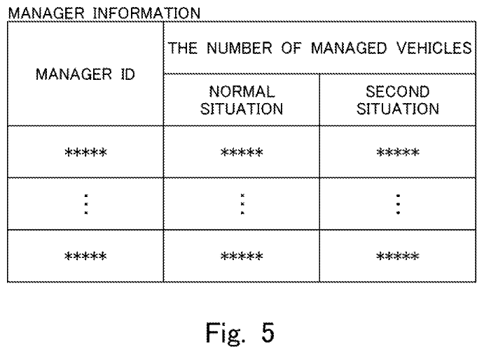

Next, a functional configuration of the management server 200 constituting the management system 1 according to the present embodiment will be described based on FIGS. 4 and 5. FIG. 4 is a block diagram schematically illustrating an example of the functional configuration of the management server 200. The management server 200 is configured including a controller 201, a communication unit 202 and a manager information database 203 (manager information DB 203).

The controller 201 has a function of performing arithmetic processing for controlling the management server 200. The controller 201 can be realized by the processor 210 of the management server 200. The communication unit 202 has a function of connecting the management server 200 to the network N1 and the in-area network. The communication unit 202 can be realized by the communication I/F 240 of the management server 200.

The controller 201 receives situation information from the vehicles 100 by the communication unit 202. Further, the controller 201 transmits the situation information received from the vehicles 100 to the manager terminals 300 by the communication unit 202. At this time, the controller 201 transmits situation information about vehicles 100 managed by each manager 30 to a corresponding manager terminal 300. Further, the controller 201 relays telephone conversation between a vehicle 100 and a corresponding manager terminal 300 by transmitting/receiving voice data between the vehicle 100 and the manager terminal 300. Further, the controller 201 transmits information for assisting self-driving of a vehicle 100 received from a manager terminal 300, to the vehicle 100.

The controller 201 detects a situation of each vehicle 100 based on situation information received from the vehicle 100. Specifically, the management server 200 detects the situation of each vehicle 100 by analyzing a video included in the situation information about the vehicle 100. At this time, there may be a case where a vehicle 100 comes into a predetermined situation. When detecting that a vehicle 100 is in a predetermined situation, the management server 200 changes managers of vehicles 100 other than the vehicle 100 (hereinafter also referred to as a “target vehicle 100”), which are managed by the manager 30 managing the target vehicle 100 (hereinafter also referred to as a “target manager 30”). In the present embodiment, the predetermined situation is a situation in which an abnormality has occurred in a vehicle 100 (hereinafter also referred to as “a first situation”). Further, in the present embodiment, the predetermined situation is a situation that requires an operation related to travel of a vehicle 100 by a manager 30 (hereinafter also referred to as “a second situation”).

Here, in the present embodiment, it is assumed that the target manager 30 managing the target vehicle 100 that has come into the first situation needs to focus on travel management of the target vehicle 100. In this case, the target manager 30 needs to focus on travel management of the target vehicle 100, for example, in order to cause the target vehicle 100 in which the abnormality has occurred to make an emergency stop or to make a telephone conversation with a passenger of the target vehicle 100. Therefore, the controller 201 decides one or more managers 30 other than the target manager 30 as managers to manage travel of all the vehicles 100 other than the target vehicle 100 among the plurality of vehicles 100 for which the target manager 30 manages travel, on behalf of the target manager 30. That is, the controller 201 changes vehicles 100 which the target manager 30 is responsible for so that the target manager 30 can perform only travel management of the target vehicle 100.

Further, in the present embodiment, it is assumed that it is necessary that the burden of travel management of vehicles 100 on a target manager 30 managing travel of a target vehicle 100 that has come into the predetermined second situation should be reduced. That is, it is assumed that it is necessary to decrease the number of vehicles 100 for which the target manager 30 is responsible for travel management in order that the target manager 30 pays attention to the target vehicle 100 that has come into the predetermined second situation. Therefore, the controller 201 decides one or more of managers 30 other than the target manager 30 as managers to manage travel of a part of vehicles 100 other than the target vehicle 100 among the plurality of vehicles 100 for which the target manager 30 manages travel, on behalf of the target manager 30. At this time, the controller 201 decides the vehicles 100 other than the target vehicle 100 as travel management targets by the one or more managers 30 other than the target manager 30, based on manager information stored in the manager information DB 203.

FIG. 5 is a diagram illustrating an example of a table configuration of the manager information stored in the manager information DB 203. The manager information DB 203 can be realized by the auxiliary storage 230 of the management server 200. The manager information is information is information about the number of vehicles 100 for which each manager 30 can perform travel management. As illustrated in FIG. 5, the manager information has manager ID fields and number-of-managed-vehicles fields. In each manger ID field, an identifier for identifying a manager 30 (a manager ID) is inputted.

It is assumed that the managers 30 are different in skills to perform travel management of vehicles 100. Therefore, it is assumed that the number of vehicles 100 for which each manager 30 can perform travel management is different. Therefore, in each number-of-managed-vehicles field, the number of vehicles 100 for which a manager 30 can perform travel management is inputted. The burden of travel management work is heavier in the case of a manager 30 performing travel management while performing travel management of a target vehicle 100 that has come into the second situation than the case of the manager 30 performing travel management in a normal situation. Therefore, it is assumed that the number of vehicles 100 for which the manager 30 can perform travel management in the normal situation and the number of vehicles 100 for which the manager 30 can perform travel management while performing travel management of a target vehicle 100 that has come into the second situation are different.

Therefore, in each number-of-managed-vehicles field, the number of vehicles 100 for which a manager 30 can perform travel management in the normal situation (hereinafter also referred to “the normal number of managed vehicles”) is inputted. Further, in the number-of-managed-vehicles field, the number of vehicles 100 for which, when a managed vehicle 100 has come into the second situation, the manager 30 can perform travel management together with travel management of the target vehicle 100 that has come into the second situation (hereinafter also referred to as “the particular number of vehicles”) is inputted. Here, in the number-of-managed-vehicles field, the number of vehicles smaller than the normal number of managed vehicles is inputted as the particular number of vehicles. The normal number of managed vehicles and the particular number of vehicles inputted in the number-of-managed-vehicles field are appropriately inputted by a manager or the like of the management server 200 according to skills of each manager 30.

When detecting that a target vehicle 100 has come into the second situation, the controller 201 acquires the particular number of vehicles for the target manager 30 based on the manager information stored in the manager information DB 203. The controller 201 decides vehicles 100 corresponding to the number that is a difference between the number of a plurality of vehicles 100 for which the target manager 30 performs travel management and the particular number of vehicles, as vehicles for which travel is managed by managers 30 other than the target manager 30 (hereinafter also referred to as “non-target vehicles 100”).

As the method for the controller 201 to decide the non-target vehicles 100, a publicly-known method can be adopted. The controller 201 may decide the non-target vehicles 100 corresponding to the number that is the difference between the number of the plurality of vehicles 100 for which the target manager 30 performs travel management and the particular number of vehicles, based on identifiers (vehicle IDs) for identifying the plurality of vehicles 100 for which the target manager 30 performs travel management. For example, the controller 201 arranges vehicle IDs of vehicles 100 other than the target vehicle 100, among the plurality of vehicles 100 for which the target manager 30 performs travel management, in ascending order (or descending order). Then, the controller 201 decides the number of vehicles 100 corresponding to the difference between the number of the plurality of vehicles 100 for which the target manager 30 performs travel management and the particular number of vehicles from the top (or the bottom), as the non-target vehicles 100.

Then, when detecting that a target vehicle 100 has come into a predetermined situation (the first situation or the second situation), the controller 201 decides managers of vehicles 100 other than the target vehicle 100 or non-target vehicles 100 from among managers 30 other than the target manager 30. However, there may be a case where the number of the non-target vehicles 100 exceeds a total number of the numbers of vehicles 100 that the managers 30 other than the target manager 30 can newly manage (the numbers of vehicles 100 corresponding to differences between the normal numbers of managed vehicles and the numbers of vehicles 100 for which travel is currently managed). In this case, if all managers of the non-target vehicles 100 are changed, such a manager 30 that is a manager 30 other than the target manager 30 and that has to perform travel management of the number of vehicles 100 exceeding the normal number of managed vehicles will exist. Then, there is a possibility that, among the vehicles 100 for which the manager 30 performs travel management, vehicles 100 to which sufficient attention is not paid will exist.

Therefore, if the number of the vehicles 100 other than the target vehicle 100 or the non-target vehicles 100 exceeds the total number of the numbers of vehicles 100 that the managers 30 other than the target manager 30 can newly manage, the controller 201 causes vehicles 100 other than the target vehicle 100 or non-target vehicles 100 corresponding to the number corresponding to the excess of the total number (hereinafter also referred to as “the excess number”) to stop travel. Specifically, the controller 201 decides vehicles 100 other than the target vehicle 100 or non-target vehicles 100 corresponding to the excess number among the non-target vehicles 100 as vehicles for which managers 30 cannot be decided (hereinafter also referred to as “unavailable vehicles 100”). Then, if an unavailable vehicle 100 exists among the vehicles 100 other than the target vehicle 100 or the non-target vehicles 100, the controller 201 transmits stop information for causing travel of the unavailable vehicle 100 to stop. At this time, for the unavailable vehicle 100 the travel of which has been stopped, travel management is not performed by a manager 30.

As the method for the controller 201 to decide the unavailable vehicles 100, a method similar to the method for deciding non-target vehicles 100 can be adopted. The controller 201 may decide unavailable vehicles 100 corresponding to the excess number, for example, based on vehicle IDs of non-target vehicles 100.

Further, as the method for the controller 201 to decide managers 30 other than a target manager 30 to whom responsibility for travel management of vehicles 100 is changed from the target manager 30, a publicly-known method can be adopted. The controller 201 decides the managers 30 other than the target manager 30 to whom the responsibility for travel management of the vehicles 100 is changed from the target manager 30, for example, based on manager IDs of the managers 30 other than the target manager 30. The controller 201 arranges the manager IDs of the managers 30 other than the target manager 30, for example, in ascending order (or descending order). Then, by assigning the vehicles 100 for which managers are to be changed from the target manager 30 in order from the top (or the bottom), the controller 201 decides the managers 30 other than the target manager 30 to whom the responsibility for travel management of the vehicles 100 is changed from the target manager 30. At this time, the controller 201 assigns the vehicles 100 such that the normal number of managed vehicles of each manager 30 is not exceeded.

(Change Process)

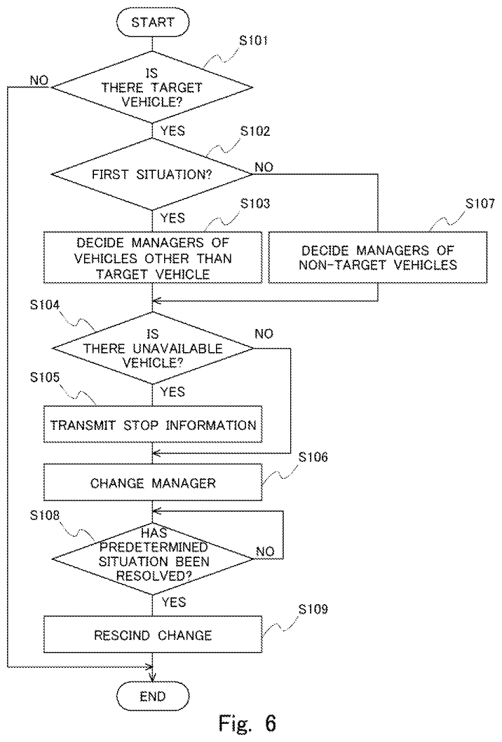

Next, a change process executed by the controller 201 of the management server 200 in the management system 1 will be described based on FIG. 6. FIG. 6 is a flowchart of the change process. The change process is a process for, when a target vehicle 100 comes into a predetermined situation, changing persons responsible for vehicles 100 other than the target vehicle 100. The change process is repeatedly executed when travel of the plurality of vehicles 100 is started.

In the change process, first, at S101, it is judged whether a target vehicle 100 exists among the plurality of vehicles 100 or not. That is, at S101, it is judged whether or not a vehicle 100 that has come into a predetermined situation (the first or second situation) exists among the plurality of vehicles 100. If a negative judgment is made at S101, it is not necessary to change responsibilities of the managers 30 who manages travel of the vehicles 100. Therefore, the change process is ended.

If a positive judgment is made at S101, it is judged at S102 whether the target vehicle 100 is in the first situation or not. If a positive judgment is made at S102, the target manager 30 needs to focus on travel management of the target vehicle 100. Therefore, at S103, managers to manage travel of vehicles 100 other than the target vehicle 100, which are managed by the target manager 30, on behalf of the target manager 30 are decided from among managers 30 other than the target manager 30. Next, at S104, it is judged whether an unavailable vehicle 100 exists or not. If a negative judgment is made at S104, a vehicle 100 that needs to be stopped does not exist because an unavailable vehicle 100 does not exist. Therefore, at S106, managers of the vehicles 100 other than the target vehicle 100 are changed.

If a positive judgment is made at S104, it is necessary to cause the number of vehicles 100 corresponding to the excess number to stop. Therefore, at S105, stop information is transmitted to the unavailable vehicles. Then, at S106, managers of vehicles 100 other than the unavailable vehicles 100, among the vehicles 100 for which the target manager 30 manages travel, are changed.

If a negative judgment is made at S102, the target vehicle 100 has been in the second situation. Therefore, at S107, managers to manage travel of the non-target vehicles 100 on behalf of the target manager 30 are decided from among the managers 30 other than the target manager 30. Next, at S104, it is judged whether an unavailable vehicle 100 exists or not. If a negative judgment is made at S104, a vehicle 100 that needs to be stopped does not exist because an unavailable vehicle 100 does not exist. Therefore, at S106, managers of the non-target vehicles 100 are changed. If a positive judgment is made at S104, it is necessary to stop vehicles 100 corresponding to the excess number. Therefore, at S105, stop information is transmitted to the unavailable vehicles 100. Then, at S106, managers of vehicles 100 other than the unavailable vehicles 100, among the vehicles 100 for which the target manager 30 manages travel, are changed.

After the managers are changed at S106, it is judged at S108 whether the predetermined situation has been resolved or not. Specifically, the controller 201 judges whether the predetermined situation has been resolved for the target vehicle 100 or not by analyzing video in situation information transmitted from the target vehicle 100. If a positive judgment is made at S108, it becomes unnecessary for the target manager 30 to pay attention to travel management of the target vehicle 100 in comparison with the case where the target vehicle 100 is in the predetermined situation. Therefore, at S109, the change of the managers made at S106 is rescinded. That is, at S109, the managers of the vehicles 100 changed at S106 are changed to the target manager 30 again. Thereby, it becomes possible to return the burden of the managers 30 other than the target manager 30 performing travel management of vehicles 100, which has been increased by the managers of the vehicles 100 being changed at S106, to the state before the managers being changed.

If a negative judgment is made at S108, the change of the managers at S106 cannot be rescinded because the predetermined situation in the target vehicle 100 has not been resolved. Therefore, the process of S108 is executed again. Then, after the process of S109 is executed, the change process is ended.

As described above, if a target vehicle 100 exists, managers of vehicles 100 other than the target vehicle 100 or non-target vehicles 100 are changed from the target manager 30 by the management system 1. Thereby, the number of vehicles 100 for which the target manager 30 manages travel decreases. Therefore, by the burden of the target manager 30 managing travel of the vehicle 100 being reduced, it becomes possible to pay attention to the target vehicle 100. Further, for the vehicles 100 other than the target vehicle 100 or the non-target vehicles 100 for which the managers have been changed, travel is managed by managers 30 different from the target manager 30. Thereby, for the vehicles 100 other than the target vehicle 100 or the non-target vehicles 100 for which the managers have been changed, travel management is safely performed by the manager 30. Further, if an unavailable vehicle 100 exists, stop information is transmitted to the unavailable vehicle 100 by the management system 1. Thereby, it becomes possible to prevent a vehicle 100 to which sufficient attention is not paid among the vehicles 100 for which the managers 30 perform travel management from existing. Thus, it is possible to enable safe travel of the plurality of vehicles 100.

(Modification 1)

In the present embodiment, as the predetermined situation, the first situation and the second situation exist. The predetermined situation, however, is not necessarily required to be the first situation and the second situation. For example, it is necessary for a target manager 30 to pay attention to travel management of a target vehicle 100 so that the target vehicle 100 does not come into contact with an obstacle that exists on a travel route of the target vehicle 100. Therefore, the predetermined situation may include a situation in which an obstacle exists on a travel route of a vehicle 100. Further, in the present embodiment, though two situations of the first situation and the second situation exist as the predetermined situation, only one situation may exist as the predetermined situation.

(Modification 2)

In the present embodiment, the management server 200 detects that the predetermined situation has occurred, based on situation information that includes video of the inside and outside of a vehicle 100. The management server 200, however, does not necessarily have to detect that the predetermined situation has occurred, based on the situation information that includes video of the inside and outside of a vehicle 100. The management server 200 may detect that the predetermined situation (the first situation) has occurred, based on a signal transmitted from a vehicle 100 when an emergency button provided in the vehicle 100 being pressed by a passenger, for example. Further, the management server 200 may detect that the predetermined situation (the second situation) has occurred, based on information and the like about the speed and position of a vehicle 100, and positions about vehicles, obstacles and the like around the vehicle 100. In this case, the predetermined situation may include a situation in which the vehicle 100 is traveling on such a road that requires the manager 30 to carefully monitor the travel of the vehicle 100 because the road width is narrow, or the road is complicated. In this case, if the vehicle 100 is traveling on a road with a narrow road width or a complicated road, the management server 200 judges that the vehicle 100 is in the predetermined situation based on the position of the vehicle 100 and the like.

### Other Embodiments

The embodiment described above is a mere example, and the present disclosure can be appropriately changed and practiced within a range not departing from the spirit of the disclosure. The processes and means described in the present disclosure can be freely combined and implemented as long as a technical contradiction does not occur.

Further, a process described as being performed by one apparatus may be shared and executed by a plurality of apparatuses. Or alternatively, processes described as being performed by different apparatuses may be executed by one apparatus. In a computer system, by what hardware configuration (server configuration) each function is realized can be flexibly changed.

The present disclosure can be realized by supplying a computer program implemented with the functions described in the above embodiments to a computer, and one or more processors that the computer has reading out and executing the program. Such a computer program may be provided for the computer by a non-transitory computer-readable storage medium that can be connected to the system bus of the computer or may be provided for the computer via a network. As the non-transitory computer-readable medium, for example, any type of disk such as a magnetic disk (a floppy (registered trademark) disk, a hard disk drive (HDD) or the like) and an optical disk (a CD-ROM, a DVD disk, a Blu-ray Disc or the like) and any type of medium suitable for storing electronic instructions like a read-only memory (ROM), a random access memory (RAM), an EPROM, an EEPROM, a magnetic card, a flash memory or an optical card are included.

What is claimed is:

1. An information processing apparatus comprising a controller comprising at least one processor, the controller being configured to execute deciding, when a first vehicle among a plurality of self-driving vehicles for which travel is remotely managed by a first manager comes into a predetermined situation that requires attention by the first manager, one or more second managers other than the first manager as managers to manage travel of one or more second vehicles other than the first vehicle among the plurality of self-driving vehicles on behalf of the first manager.

2. The information processing apparatus according to claim 1, wherein
as the predetermined situation, a plurality of predetermined situations exist, and the number of self-driving vehicles that the first manager can manage is specified for each of the predetermined situations; and
the controller decides the one or more second managers as the managers to manage travel of the one or more second vehicles on behalf of the first manager, further based on the number of self-driving vehicles that the first manager can manage.

3. The information processing apparatus according to claim 1, wherein
the number of self-driving vehicles that each of the one or more second managers can manage is specified; and
the controller decides the one or more second managers as the managers to manage travel of the one or more second vehicles on behalf of the first manager, further based on the number of self-driving vehicles that each of the one or more second managers can manage.

4. The information processing apparatus according to claim 3, wherein, if the number of the one or more second vehicles exceeds a total number of the numbers of self-driving vehicles that the one or more second managers can newly manage, respectively, the controller further executes causing travel of second vehicles corresponding to the number exceeding the total number, among the one or more second vehicles, to stop.

5. The information processing apparatus according to claim 1, wherein, when the predetermined situation is resolved, the controller further executes returning the management of travel of the one or more second vehicles that the one or more second managers manage on behalf of the first manager to the first manager.

6. The information processing apparatus according to claim 1, wherein the predetermined situation is a situation in which an abnormality has occurred in the first vehicle.

7. The information processing apparatus according to claim 1, wherein the predetermined situation is a situation that requires an operation related to travel of the first vehicle by the first manager.

8. The information processing apparatus according to claim 1, wherein the predetermined situation is a situation in which an obstacle exists on a travel route of the first vehicle.

9. An information processing method comprising deciding, when a first vehicle among a plurality of self-driving vehicles for which travel is remotely managed by a first manager comes into a predetermined situation that requires attention by the first manager, one or more second managers other than the first manager as managers to manage travel of one or more second vehicles other than the first vehicle among the plurality of self-driving vehicles on behalf of the first manager.

10. The information processing method according to claim 9, wherein
as the predetermined situation, a plurality of predetermined situations exist, and the number of self-driving vehicles that the first manager can manage is specified for each of the predetermined situations; and
the one or more second managers are decided as the managers to manage travel of the one or more second vehicles on behalf of the first manager, further based on the number of self-driving vehicles that the first manager can manage.

11. The information processing method according to claim 9, wherein
the number of self-driving vehicles that each of the one or more second managers can manage is specified; and
the one or more second managers are decided as the managers to manage travel of the one or more second vehicles on behalf of the first manager, further based on the number of self-driving vehicles that each of the one or more second managers can manage.

12. The information processing method according to claim 11, further comprising causing, if the number of the one or more second vehicles exceeds a total number of the numbers of self-driving vehicles that the one or more second managers can newly manage, respectively, travel of second vehicles corresponding to the number exceeding the total number, among the one or more second vehicles, to stop.

13. The information processing method according to claim 9, further comprising returning, when the predetermined situation is resolved, the management of travel of the one or more second vehicles that the one or more second managers manage on behalf of the first manager to the first manager.

14. The information processing method according to claim 9, wherein the predetermined situation is a situation in which an abnormality has occurred in the first vehicle.

15. The information processing method according to claim 9, wherein the predetermined situation is a situation that requires an operation related to travel of the first vehicle by the first manager.

16. The information processing method according to claim 9, wherein the predetermined situation is a situation in which an obstacle exists on a travel route of the first vehicle.

17. A non-transitory storage medium storing a program for causing a computer to execute an information processing method, wherein
the information processing method comprises deciding, when a first vehicle among a plurality of self-driving vehicles for which travel is remotely managed by a first manager comes into a predetermined situation that requires attention by the first manager, one or more second managers other than the first manager as managers to manage travel of one or more second vehicles other than the first vehicle among the plurality of self-driving vehicles on behalf of the first manager.

18. The non-transitory storage medium according to claim 17, wherein
as the predetermined situation, a plurality of predetermined situations exist, and the number of self-driving vehicles that the first manager can manage is specified for each of the predetermined situations; and
in the information processing method, the one or more second managers are decided as the managers to manage travel of the one or more second vehicles on behalf of the first manager, further based on the number of self-driving vehicles that the first manager can manage.

19. The non-transitory storage medium according to claim 17, wherein
the number of self-driving vehicles that each of the one or more second managers can manage is specified; and
in the information processing method, the one or more second managers are decided as the managers to manage travel of the one or more second vehicles on behalf of the first manager, further based on the number of self-driving vehicles that each of the one or more second managers can manage.

20. The non-transitory storage medium according to claim 19, wherein
the information processing method further comprises causing, if the number of the one or more second vehicles exceeds a total number of the numbers of self-driving vehicles that the one or more second managers can newly manage, respectively, travel of second vehicles corresponding to the number exceeding the total number, among the one or more second vehicles, to stop.
